(19) United States
(12) Patent Application Publication
(10) Pub. No.: US 2005/0036267 A1
(43) Pub. Date: Feb. 17, 2005

(54) Clamp for holding and efficiently removing heat from workpieces

(76) Inventors: Stephen Edward Savas, Fremont, CA (US); John Zajac, San Jose, CA (US)

Correspondence Address: EDWARD S. WRIGHT, 1100 ALMA STREET, SUITE 207, MENLO PARK, CA, 94025, US

(21) Appl. No.: 10/851,760

(22) Filed: May 20, 2004

Related U.S. Application Data
(60) Provisional application No. 60/472,354, filed on May 20, 2003.

(51) Int. Cl. H02H 1/00

(52) U.S. Cl. 361/234

(57) ABSTRACT

The invention described in this disclosure is an apparatus and method for clamping semiconductor wafers or other substrates or workpieces during etching, CVD, or surface modification processes. The purpose of the invention is to achieve improved heat transfer during processing between the wafer/substrate and a temperature controlled pedestal used for supporting it in the process chamber. The typical level of process heat put into the wafer during plasma-based etching or deposition processes will be up to about 10 Watts per centimeter squared while the maximum acceptable temperature differential between wafer/substrate and pedestal is less than about 100 Celsius. In such low gas pressure environments typical for plasma-based processes, the heat removal from the wafer/substrate by gaseous conduction may be inadequate to meet requirements. This invention achieves excellent heat transfer to the pedestal from the wafer/substrate when there is a thin, resilient, electrically insulating layer (tape) bonded to the wafer/substrate or the pedestal. Wafer/substrate clamping for improved process heat removal is achieved by a combination of vacuum clamping of the wafer/substrate beginning prior to evacuation of the processing chamber, along with or followed by electrostatic clamping of the wafer/substrate which continues during processing. The invention also permits the wafer/substrate to be rapidly and safely released from the electrostatic clamping when the chamber is returned to atmospheric pressure by a providing a slight pressure increase, above atmospheric pressure, between wafer and pedestal. The pedestal may have some roughening or narrow grooves on the wafer clamping surface, and some small holes from its surface leading to an evacuated plenum or channel within the pedestal. Alternatively, the pedestal may have a layer of a porous metal extending from its surface down to the evacuated channel or plenum which permits gas to be evacuated. These structures allow vacuum pumping of gas that might otherwise be trapped between the insulating layer and the pedestal. When a wafer/substrate is placed on the pedestal by loading at atmospheric pressure, vacuum pumping through the pedestal is commenced. This causes the workpiece to be pressed to the pedestal clamping surface with approximately atmospheric pressure compressing the soft layer against its clamping surface. This provides sufficient contact of the soft layer with the pedestal to greatly improve heat transfer from the wafer/substrate to the pedestal. A voltage is applied to the pedestal, beginning any time after the wafer is on the pedestal, to further clamp the wafer electrostatically. As the processing chamber is then pumped down to operating pressure for processing the electrostatic clamping voltage maintains sufficient pressure of the wafer/substrate against the pedestal to maintain the heat conductive contact between the soft layer and the pedestal. This permits good heat conduction to be maintained during the low pressure plasma-based etching or CVD processing. Following processing when the wafer/substrate is to be removed it may be rapidly de-clamped from the electrostatic clamping by application of a slight over-atmospheric pressure in the reservoir or pumping channels within the pedestal.

### RELATED APPLICATION

This application is based upon Provisional Application No. 60/472,354, filed May 20, 2003, the priority of which is claimed.

### BACKGROUND OF THE INVENTION

1. Field of Invention

This invention pertains generally to the processing of semiconductor wafers and, more particularly, to a clamp for holding workpieces so that process heat removal is efficient and consistent.

2. Related Art

Typically, wafers/substrates are electrostatically clamped during many plasma-based Fabrication processes, such as etching or CVD, to facilitate heat transfer between the wafer/workpiece and the support pedestal. This is particularly the case in processing of semiconductor wafers to make large scale integrated circuits where process heat normally needs to be removed from the wafer. It is also the case in processing substrates for flat panel displays. Normally, in these technologies up to about two to three Watts per centimeter squared of process heat needs to be removed with the wafer temperature held to less than about 100 Celsius.

Such processes typically are performed at gas pressures of about or less than several Torr. Such low gas pressure in the narrow space between the wafer and the pedestal would result in poor heat transfer from workpiece to a temperature controlled pedestal. This situation is often dealt with in IC Fabrication by injection of a more conductive gas such as helium between the wafer and the pedestal at a higher pressure, typically about 10 to 20 Torr, while the wafer is electrostatically clamped. See FIG. 1 for a typical electrostatic chuck of the monopolar type. In these cases the clamping voltage is less than or about a few kilovolts and clamping pressures are less than a pound per square inch. Under such conditions the steady state temperature differential between the wafer and the pedestal is at least 20 to 30 degrees Celsius for each Watt per square centimeter of heat put into the wafer or substrate. Often the etching or deposition rate varies approximately linearly with the amount of process heat deposited in the substrate or wafer. Thus, if process heat loads are high (>3 Watts per centimeter squared) due to high etching rates or deposition rates, while the wafer temperature must be kept below 100 Celsius, due to wafer/substrate or process constraints, then current technology would require the pedestal to be cooled to below freezing temperature. This can cause problems including condensation on parts of the pedestal exposed to atmosphere and large temperature variations of the pedestal made of parts with different coefficients of thermal expansion. In some cases there may be other problems including condensation of process reaction products on the pedestal. In other cases where high heat removal and low substrate temperature is required, such a low pedestal temperatures might be required that coolant viscosity or chiller limitations would not permit it.

In some cases where the wafer/substrate needs to be etched or deposited on its backside, the side with integrated circuits or other sensitive components would be pressed onto the hard surface of the pedestal during clamping. Heat needs to be removed uniformly from the wafer/substrate yet the structure on the surface will cause it to have an irregular spacing from the flat pedestal surface resulting in uneven rates of cooling by gaseous heat conduction when electrostatic clamping is used. When the side of the wafer with devices on it is clamped to a hard surface high mechanical stresses may cause wafer breakage (especially for wafers that have been thinned by grinding) and/or surface damage. Also, the presence of very small conducting structures on the clamped surface can lead to very high electric fields during electrostatic clamping which can cause electrical breakdown in the thin dielectric insulator covering the integrated circuit. This remains the case even when a conventional protective organic polymer such as photoresist several to ten microns thick might be applied to the surface.

The wafers, whether silicon or other materials, on which integrated circuits are fabricated are currently hundreds of microns in thickness. The portable electronic devices (such as cellular phones and smart cards) which use an increasing number of semiconductors require that the packaged integrated circuit chips (IC chips or IC's) be of the same order of thickness or less than that of the original wafer. In order to accomplish such IC packaging these wafers are increasingly being thinned from the backside after the circuits are manufactured on the front side. Such wafer thinning almost always involves grinding away (the most economic method for removing a large amount of wafer material) a good fraction of the wafer material on the backside thus leaving it reduced in thickness. Such grinding, however, leaves IC's that have scratches in their backsides, which weakens them. Such scratches are almost always confined to a layer of material within a few tens of microns of the surface left by the grinding. When such chips are mounted to a wiring board to make electronic products the stresses associated with the flexing of the board, or the thermal expansion of the board (when the IC's are in operation and producing heat) can cause the semiconductor material to break. However, if the wafer material within the scratched and damaged layer is removed by a soft etching method then the strength of the wafer material is restored somewhat and the failure rate of the packaged IC's is much reduced. When the wafer is very thin and/or fragile and the mechanical stresses on that material due to clamping of its irregular surface topography would be sufficient to cause damage or even breakage. This damage is especially likely when a very thin wafer that has been ground down on the backside is being clamped. This is particularly true when the processed side of the wafer or substrate (the side face down on the pedestal) has had either solder bumps or plated contact studs put onto it. In this case the stresses on the wafer when clamped to a hard surface would very likely be unacceptable.

In order to mitigate such mechanical and electrical stresses Savas and Zajac in U.S. Pat. No. 6,501,636 describe an apparatus in which a soft thermally conductive layer was attached to the pedestal on which an electrostatic potential was imposed. In this case the irregularities on the front side of the wafer or substrate are cushioned by the soft layer. Adequate pressure for making good thermal contact is provided by having atmospheric pressure on the exposed surface while pumping to vacuum at the interface between wafer and pedestal. This causes the wafer with an irregular surface to press into the soft material and make good contact for heat conduction over a very large fraction of the surface. Yet, such an elastomeric layer will become dirty or degrade in its function over time and by the etching of thousands of wafers or substrates, thereby necessitating frequent replacement. In-situ cleaning processes might also degrade this layer, necessitating more frequent replacement or the spreading of elemental contamination which would compromise IC yields. Further, small particles from the elastomer might become attached to the surface of the wafer or substrate and be difficult to remove from recessed spaces on the substrate surface. Hard particles such as silicon dust will reduce the heat conduction from wafer to the elastomer and therefore need to be kept off the pedestal and wafer—which may not always be easy.

In some wafer processes it has been possible to use compressible elastomeric materials to facilitate heat transfer from wafer to pedestal. Normally, these situations permit the wafer/substrate to have a peripheral mechanical clamp or to have atmospheric pressure pressing the wafer or substrate into the cooled surface. (See Varian Patent on Elastomer) The peripheral clamp is normally used with a slightly convex pedestal surface so that the pressure of the wafer against the pedestal and elastomer is uniform resulting in uniform cooling and temperature of the surface being processed. However, use of electrostatic clamping with such an elastomer is not used where a high rate of heat removal is required. The reason is that the elastomer typically has substantial thickness resulting in a small resultant electrostatic clamping force when acceptable levels of clamping voltage are used (up to a maximum of about 3 kilo Volts). However, use of clamping Voltages of a kiloVolt or more will result in very high electric fields at the high points made of conducting materials. This is likely to cause electrical breakdown in the elastomer or soft plastic. Use of lower clamping voltages with such elastomers produces such modest clamping force (of order a fraction of a PSI) that this is inadequate to give good heat conduction from substrate to pedestal. Use of a peripheral mechanical clamp is also not acceptable when very fragile substrates are being etched such as silicon wafers that have been ground down to less than 100 microns thickness or Gallium Arsenide wafers.

Because of such difficulties with soft layers bonded to the pedestal, it would be desirable to have the soft layer attached to the wafer or substrate itself. It would be important that the layer would be inexpensive and could easily and completely be removed leaving no trace on it surface—but this is less critical when the fabrication process has been completed on the front side. Such a layer could cushion or absorb the irregularity of the surface in the viscous adhesive and reduce electric fields and stresses on the substrate material. In particular, this is the case where the wafers to be etched on the back side have been ground on that side and have had “bumps” of solder or electroplated metal put onto the front side. In this case the high “bumps” are well cushioned when the side of the wafer with devices on it is clamped to a hard surface Complicating the cooling of such wafers is the fact that it is essential to protect the device side of the wafer where the solder balls or metal pillars are mounted so that no damage to the exposed IC's is caused in clamping or handling such wafers. Such handling includes transporting the wafers into and out of the grinding and etching systems and mounting wafers during both grinding and etching operations. Protecting such vulnerable wafers is usually done with a plastic polymer tape applied to the device side of the wafer whereon the solder balls or pillars are. Such tape covers the whole of the device side and is typically between 70 microns and 120 microns in thickness. The layer of adhesive that holds the tape to the wafer is typically of the order of ten microns to a few tens of microns thick.

In some cases where the bumps on the wafer are a hundred microns or more in height the tape may have an adhesive layer that is greater than the height of the bumps so that they are completely cushioned by the very soft adhesive.

Typical electrostatic wafer clamping to the taped side of such wafers will not give effective thermal contact of the wafer with the pedestal due to the thickness of the dielectric layer, its low dielectric constant (normally less than 3.0) and the normal maximum of a kilo Volt for the clamping voltage. The clamping pressure is too low. In order to make such wafer clamping with significant pressure with a roughly 100 micron-thick plasma tape in between would require much higher clamping voltages than are typically employed, resulting in high likelihood of arcing or electrical breakdown of the dielectric layer or electrostatic damage to the IC.

Therefore, no previously existing technology is adequate for etching wafers or substrates at extremely high rates using RIE or other method having a high rate of wafer/substrate heating, while keeping wafer temperatures low.

### DESCRIPTION OF THE INVENTION

It is the object of the disclosed invention to effectively and safely clamp wafers or substrates to allow efficient heat transfer from them to a temperature controlled pedestal during plasma processing. This clamping system and method works with wafers or substrates that either have a soft plastic or elastomeric surface which completely covers one side, or that have a layer of such a soft plastic/elastomer applied to one side. In order to permit electrostatic clamping the soft or elastomeric layer should either be an electrical insulator or have very high electrical resistance. The clamping method employs a combination of vacuum and electrostatic pressure in sequence. Such clamping on the wafer or substrate causes the plastic or elastomeric material to conduct the heat from plasma processing efficiently from wafer or substrate to the temperature controlled pedestal thereby maintaining acceptably low wafer or substrate temperatures.

The pedestal to which wafers or substrates are to be clamped should be designed and built to connect to a source of vacuum pumping and to a source of electrical potential. Such pumping is connected to a reservoir or series of channels within the pedestal which further connect to one or more holes that pass through to the surface of the pedestal upon which wafers or substrates will be clamped. The surface upon which wafers or substrates will be clamped may in some embodiments have fine grooves in it which do not pass beyond the area upon which the wafers or substrates will always cover. This permits the evacuation of the space between wafer or substrate and the pedestal. The pedestal also needs to have one or more electrically conducting plates or structures at or near its surface where the wafer or substrate will be positioned, or be made of metal itself. Such plates or the pedestal itself, if made of metal, need to have metal wire(s) or other connection to a source of electrical potential which may be used to provide electric current and impose an electrical potential on the pedestal or conducting plates.

The vacuum/electrostatic chuck in this invention may either use the basic monopolar electrostatic chuck or bi-polar type. The monopolar typically employs a single dielectric insulating layer between a base, which may be made electrically charged, and a conducting or dielectric workpiece which is to be held. A simple example of our invention utilizing a monopolar electrostatic chuck is shown in FIG. 2. In this device, a wafer 201 having a side covered by a thin layer of soft plastic material, 202, is clamped to the pedestal, 203, which is pumped through small holes, 204, connecting to a series of channels, 205, within the pedestal. The channels are connected to a source of vacuum pumping, 206. There is a valve in the vacuum line, 207, leading to the pedestal which may be closed when pumping is not desired or opened to evacuate the channels within the pedestal. The pedestal may be electrically biased by voltage source 208 connected to the pedestal. Within the pedestal is a channel for a coolant which may circulate during processing or be held so as to provide control of the pedestal temperature at a desired level. Use of a thermoelectric cooler is also acceptable. Typically, such a pedestal temperature is chosen so that when added to the maximal temperature differential between wafer and pedestal the total is safely less than the maximum allowable wafer temperature. The temperature differential between wafer and pedestal will be a function of the rate of heat removal from the wafer and the heat conductivity of the soft plastic layer and the interface with the pedestal considered in series.

The method of employing this invention consists of an initial clamping at or near atmospheric pressure followed by electrostatic clamping at a lower pressure which continues during wafer processing. The initial clamping is done by applying vacuum pumping to the wafer holding pedestal, while the ambient chamber pressure is at or near atmosphere. This evacuates the space between the wafer/substrate and the pedestal. The pressure differential of about an atmosphere between the side of the wafer to be processed and the side adjacent to the pedestal causes the wafer to be pressed into the pedestal at with a pressure of up to or about a hundred thousand Newtons per meter squared which causes good heat conductive contact between the soft surface and the pedestal. Once the wafer has been vacuum clamped the chamber may be closed to atmosphere or other source of gas pressure and then pumped down to the pressure appropriate to plasma processing. At some time during the pumping down of the chamber an electrical potential is applied to the electrostatic chuck which potential continues during plasma-based processing. This clamping is done with a minimum pressure of between a few thousand and ten thousand Newtons per square meter. In this way the pressure holding the wafer to the pedestal never falls below some critical minimum, because if the pressure was to fall below the critical minimum the soft elastomeric material would, to a substantial degree, lose its highly heat-conductive contact with the pedestal.

In some embodiments gas pressures during processing may be a few tens of Torr or less. In fact, there is no lower limit to the gas pressure in the processing chamber when using this cooling method.

The nature of such elastomeric materials is that under atmospheric pressure they make a good “seating” of the soft surface to the pedestal surface by which heat is well conducted from elastomer to pedestal. This good contact is maintained so long as the pressure holding the elastomer to the pedestal remains above a minimal level—approximately a few thousand to ten thousand Pascals. This pressure is easy to maintain with the electrostatic clamping at voltages less than or about a kilovolt.

Finally, when processing is finished and the wafer/substrate is to be released the vacuum clamping on the wafer/substrate backside may be terminated, as well as the electrostatic clamping, to permit release. If there is some difficulty in releasing the wafer/substrate from the electrostatic clamp then a small flow of gas may be introduced between wafer/substrate and pedestal—where before there had been vacuum—to achieve very slightly more than chamber ambient pressure (which is near or at atmospheric pressure) to push the wafer/substrate away from the pedestal and release it from residual clamping forces.

The disclosed invention avoids high mechanical stress on wafers/substrates having surface irregularity by having a soft plastic tape or elastomer applied to the substrate prior to insertion into the processing system. The tape or elastomer may have a layer of adhesive which is visco-elastic and is thick enough to absorb the surface irregularities of the side of the wafer opposite to that being processed. Such adhesive may be electrically insulating or conductive. The use of a covering soft dielectric serves two important functions. It cushions the irregularities in the active side of the wafer thereby yielding less stress on the sensitive surface structure. It also reduces the electric field associated with conducting structures on the active side of the wafer/substrate during electrostatic clamping thereby reducing the likelihood of electric breakdown of any insulating layer. By using atmospheric pressure for clamping prior to processing, it avoids the high electrical stresses that might damage the wafer or insulating layer if good conductive contact had to be achieved by use of electrostatic clamping alone. Such clamping forces are quite high and would entail very high voltage electrostatic clamping when using such a plastic or elastomeric layer between wafer or substrate and pedestal. This may be especially useful when the wafer/substrate is being processed on its “back” side while the “front” side is that used to conduct heat to the pedestal. In this case there may be substantial irregularity in the surface facing the pedestal.

In some cases there may be a need to have such plasma processing utilizing this type of clamping done with wafers or substrates having plastic layers on them but which do not have sufficient softness or resiliency to make good thermal contact to a pedestal with hard metal or insulator surface. In this case there may also be a soft elastomer which is attached by an adhesive to the pedestal surface (As in Savas and Zajac, U.S. Pat. No. 6,501,636). Such layer of elastomer may be used for processing a multiplicity of wafers or substrates. It is more efficient if it is used for a large number and only replaced when the function has been degraded by use. It is also the case that plasma or wet chemical cleaning of the chamber may be needed—even on a frequent basis. In this case it is useful that the plastic/elastomeric layer on the pedestal be resistant to the cleaning method, protected during such cleaning or processing, or replaced afterward. Such layer should be penetrated by the holes that connect to the source of vacuum. Alternatively, the layer may be somewhat porous so that the vacuum may penetrate it across its area. Such porosity should not compromise its function in transferring heat from the wafer or substrate to the pedestal. The elastomeric layer may or may not have channels in its surface but needs to be able to conduct gas from the interfacial region to the pumping channels in the pedestal.

The pedestal, which is the apparatus for this invention, may be made entirely from a metal or may be made of a metal with various insulating parts. The surface of the pedestal may be a hard electrical insulating material such as ceramic or plastics having sufficient heat conductivity. It is desirable in some embodiments if the vacuum channels and the surface of the pedestal are all made from electrically insulating material without gaps so that the clamping voltage applied to the metal part of the pedestal could not conduct electric current through the low pressure gas to the back of the wafer or substrate. Such current might provoke some electrical discharge phenomena that would affect processing or clamping. It is desirable that if an insulating layer is on the pedestal top surface that it be thin and well bonded to the metal so that it does not greatly increase required clamping voltage and does not impede heat transfer. In some embodiments the holes from the pumping channel to the surface of the pedestal may be numerous and closely spaced so that no gas conducting grooves may be needed. In other embodiments the grooves may be used in the top pedestal surface and a smaller number and density of holes used for pumping the interfacial region between wafer and pedestal. In the event that a thin substrate or wafer is used one needs to make the holes and grooves sufficiently narrow so that the wafer temperature does not have substantial high regions above such features. This means that the width of such holes and grooves depends on the thickness and thermal conductivity of the wafer or substrate being processed. In the case of the etching of very thin, backside ground silicon wafers the wafer thickness may be 50 micro-meters or less (0.002″). In this case the grooves and holes need to be less than about three to four times the combined thickness of wafer and soft plastic layer together. In this case the variation in temperature on the wafer surface is less than about 5 degrees C., which is usually acceptable. The grooves and holes should have such density as to leave no area larger than about an inch in size in any direction, depending again on the thickness of the substrate. Very thin substrates may need to have hole/groove patterns intersecting every square in a 6 millimeter evenly spaced grid. This insures that gas is well evacuated from the wafer backside at initial pumpdown. Narrow grooves and holes also minimize the mechanical stresses on the wafer or substrate which is important for the very thin wafers now being manufactured by backside grinding.

The vacuum pumping of the channels in the pedestal should be done with good flow conductance, but when electrostatic clamping is done while the gas pressure in the line is low, it may cause arcing in the pumping line. This can be avoided in some embodiments by lining the vacuum channels and holes with a continuous insulating layer. Anodization may be suitable for this purpose. However, an alternative embodiment uses an insulating vacuum break, which prevents long electron path length where electric fields might be high. Such vacuum electrical breaks are commonly used in plasma processing apparatus to permit gas to be supplied to an electrode that is powered.

In some embodiments where the vacuum channel is effectively lined with electrical insulating layer it may be acceptable to clamp conducting hard surfaced wafers such as silicon using such a pedestal which has a somewhat soft—elastomeric surface. The method would be the same—the wafer would first be clamped by evacuating the interface region between wafer and pedestal when the wafer is put on the pedestal. This requires that the process chamber be at a substantial fraction of atmospheric pressure when the wafer is loaded. Once the wafer is vacuum clamped to the pedestal it makes good heat conductive contact with the soft surface the chamber is pumped to processing pressure. As the chamber is being pumped the electrical potential is applied to the pedestal to cause the wafer to be electrostatically clamped with a requisite minimum pressure, before the chamber pressure goes below that minimum clamping pressure, for maintaining good thermal contact. In this manner ordinary silicon wafers and hard surface substrates may be clamped so as to conduct heat very well to a temperature controlled pedestal.

In this embodiment the vacuum/electrostatic clamp of the invention, a cooled or temperature controlled metal or other solid conducting base serves as a support for elastic and/or compressible interfacial layer(s) which together constitute a pedestal for the device. The clamp may employ one or more interfacial layers, at least one of which is insulating, which are bonded or in excellent thermal contact with each other and the base and which will be in contact with the workpiece or wafer to be clamped. The interfacial layer(s) must be either slightly compressible and/or elastic to make best thermal conductive contact. Some layer, which would best not be the top layer, may be a hard material. That layer may in some embodiments be a plastic flowable material. All layer(s) should have fairly good thermal conductivity so as to not impede the flow of heat from a workpiece or wafer to the cooled support base.

Such a method also works well with a workpiece having a bumpy side, which is facing the interfacial layers. It is clamped in contact with these layer(s) and they are able to compress in the bump locations to the extent that the bumps are fully absorbed so that essentially the entire surface of the workpiece is in contact with the layer(s). This should be such that the compressive force at the bumps that causes the interfacial layer(s) to compress, is not so large that it causes undesirable levels of stress in the wafer through the attached bumps. The insulating layer need not be the same as the compressible layer. It is an alternative embodiment of this invention in which two interfacial layers are employed of which the lower layer is a conducting layer that is compressible, and the upper layer is an electrical insulating layer which is at least slightly elastic. In this case the bumps on the wafer, when clamped to the pedestal, compress the conducting compressible layer and cause a slight stretching in the insulating layer above. These two layers should be bonded together such that there are very few, and only very small, bubbles which are trapped between the layers.

Such compressible or soft material may be one of many types of materials that are commercially available. One such compressible material could be a rubber or latex. Another type could be a material called elastomer, which is commercially available and may have higher dielectric constant and thermal conductivity than some plastic materials. To be optimal if it is an insulator, such a material should have both a moderate or higher dielectric constant, and good dielectric breakdown strength. This is important since the electric field at the bumps may be quite high when the clamping voltage is applied to the pedestal base and the wafer is connected to an almost grounded or grounded entity. The bumps of greatest concern are about 0.1 mm in diameter, which means that the electric field strength at the surface of the bumps may be quite high.

As illustrated in FIG. 3, the clamp includes a single layer dielectric which serves as the interlayer for the clamping of the bumpy wafer 302. This interlayer is clamping a wafer 301 with bumps 306. The pedestal base 303 is connected to a biasing power supply 304 and the wafer to a grounding lead 305. When the voltage is applied to the base the bumpy wafer is clamped so that the bumps become completely immersed in the dielectric. The dielectric may be an elastomer or a rubber-like material. In this embodiment the thickness of the interlayer is between about 0.1 mm and about 0.5 mm. This is thick and compressible enough to absorb the height of the bumps without excessively stressing the wafer 301. Typical voltages required for this clamping with sufficient force to give good thermal conduction from the wafer to the interlayer dielectric depend on the thickness and dielectric constant of the interlayer. For elastomers of normal quality the dielectric constant can be more than 4.0 and the clamping voltage for a 0.2 mm dielectric will be about 1,000 Volts and never need to exceed 2,000 Volts.

In the second embodiment of this invention the dielectric layer is formed from two materials, the lower of which may be a high quality electrical insulator, which may also be harder. The upper layer in this case would then be a layer of softer elastomer dielectric so it can accommodate when the bumps press into it as the wafer is clamped.

In embodiments where rf power is used to make the plasma these insulating layers need to have low loss tangents for rf electric fields so that there is minimal loss of power in the dielectric. The upper elastic layer needs to be from about 0.02 mm thick to as much as 1 mm thick. The single layer or combined multi-layer dielectric elastomer should be made of a material with a high dielectric strength at least two kV per 0.1 mm thickness. It is also desirable for this material to have a high dielectric constant, if possible greater than 3.0 so that the clamping voltage required is minimized while the safety factor for breakdown of the layer is maximized. Typical clamping voltages for a dielectric of 0.2 mm thickness would be from as little as several hundred Volts to as much as 2,000 Volts, depending on the clamping force required to make good thermal contact between the wafer and the dielectric upper layer of the chuck. Heights of typical bumps may be from 0.05 mm to as much as 0.3 mm.

The invention has a number of important features and advantages. It permits improved heat transfer to or from workpieces whose gripped surface has irregularities of such size that would prevent efficient heat transfer to a conventional electrostatic clamping structure. Clamped surfaces with solder balls attached to the bond pads (of all of the integrated circuits on the front-device-side) for flip-chip type packaging to be adequately clamped with bumpy side facing to a heat removing pedestal. Such clamping permits processing with a high rate plasma etching, CVD or other operation in which there is significant heat flux to the wafer.

It is in general an object of the invention to provide a new and improved combined vacuum and electrostatic clamp for holding workpieces with soft electrically insulating surface coverings.

Another object of the invention is to provide an vacuum and electrostatic clamp of the above character which overcomes the limitations and disadvantages of the prior art.

### BRIEF DESCRIPTION OF THE DRAWINGS

FIG. 1 is a side elevational view of a monopolar chuck of the prior art.

FIG. 2 is a side elevational view of one embodiment of a vacuum and electrostatic clamp incorporating the invention.

FIG. 3 is a side elevational view of one embodiment of a vacuum and electrostatic clamp employing a soft dielectric layer bonded to the pedestal which is capable of clamping a “bumpy” wafer.

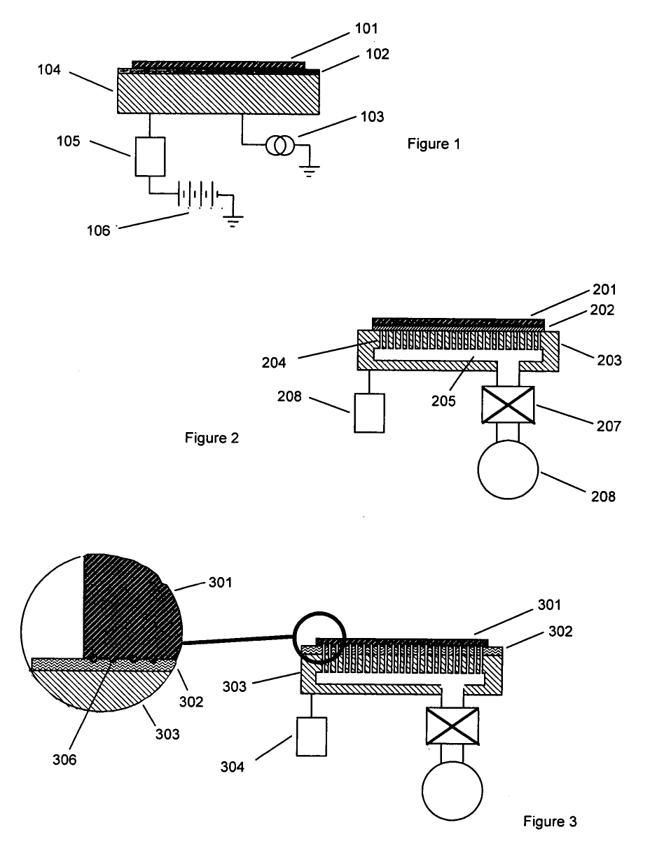

It is apparent from the foregoing that a new and improved electrostatic clamp has been provided. While only certain presently preferred embodiments have been described in detail, as will be apparent to those familiar with the art, certain changes and modifications can be made without departing from the scope of the invention as defined by the following claims.

1. A Vacuum and Electrostatic clamping apparatus for clamping wafers or substrates, which have a soft plastic or elastomeric side or covering, to be processed in a plasma reactor, comprising:
a base which is made substantially from electrically conducting material, and having internal gas conducting channels which connect to the clamping surface;
a direct current source capable of providing several hundred volts or more connected to the base; and
a source of vacuum pumping and a pumping line connecting to the pedestal.

2. The apparatus of claim 1 wherein the pedestal has a top layer which is a porous metal with conductance for gas flow from top surface to gas conducting channels of at least 0.1 liter per second at gas pressures above one Torr.

3. The apparatus of claim 1 wherein the wafer or substrate covering is a layer of soft plastic material attached to it with an adhesive.

4. The apparatus of claim 1 wherein the layer is a single layer of elastomeric material attached with an adhesive.

5. The apparatus of claim 1 wherein the internal gas conducting channels connect to the clamping surface by one or more small holes.

6. The apparatus of claim 1 wherein the surface of the pedestal is grooved with grooves not to extend beyond the area covered by the clamped wafer or substrate.

7. The apparatus of claim 1 wherein the pedestal is cooled or kept at a regulated temperature.

8. A Vacuum and Electrostatic clamping apparatus for clamping wafers or substrates to be processed in a plasma reactor, comprising:
a base covered by a soft, electrically insulating sheet; which base also has elements of electrically conducting material extending roughly under the wafer or substrate that is to be clamped; and having channels which are connected to the clamping surface;
a current source capable of providing several hundred volts or more connected to the conducting elements;
a source of vacuum pumping with a pumping line connecting to the pedestal;
a sheet of electrical insulating material which is attached to and covers the base such that there is good thermal conduction from the sheet to the base, the sheet comprising one or more layers, such that the sheet is compressed to make good thermal contact with the clamped wafer or substrate.

9. A method for clamping wafers or substrates to remove heat from an etching, CVD or surface modification process wherein:
A wafer or substrate which has been covered by a soft plastic, elastic or elastomeric material or has had a layer of such material bonded to it, is first clamped to a wafer holding pedestal by evacuating through the pedestal the area between the pedestal and the material. Such clamping being adequate to provide good heat conduction between wafer or substrate and pedestal.
The plasma processing chamber is then evacuated and a voltage of at least several hundred volts is applied to one or more electrically conducting part(s) of said pedestal so that the good heat conduction across the interface between pedestal and the soft layer bonded to the wafer or substrate is maintained.
The wafer or substrate is processed while the electrostatic clamping force is maintained to continue the good heat conduction across the interface between wafer covering and the pedestal.

10. The method of claim 8 wherein the pedestal is temperature regulated or cooled by a circulating fluid.

11. The method of claim 8 wherein the wafer is loaded into the processing chamber at an ambient pressure that is at least 15% of atmospheric.

12. A method for clamping wafers or substrates to a pedestal (which is temperature controlled or cooled and has a compressible insulating covering) to remove heat from an etching, CVD or surface modification process wherein:
A wafer or substrate is first clamped to the wafer holding pedestal by evacuating through the pedestal the area between the pedestal and the wafer or substrate. Such clamping being adequate to provide good heat conduction between wafer or substrate and the soft covering, and through it the pedestal.
The plasma processing chamber is then evacuated and a voltage of at least several hundred volts is applied to one or more electrically conducting part(s) of said pedestal so that the good heat conduction is maintained across the interface between pedestal and a soft layer placed on the pedestal.
Such electrostatic clamping is then maintained during the processing of the wafer so that the heat from the process is conducted to the pedestal.
The wafer is then released from the electrostatic and vacuum clamping after processing but prior to removal from the chamber.

13. The method of claim 10 wherein the wafer is released from electrostatic clamping following processing by removing the clamping voltage and flowing a slight amount of gas at a pressure very slightly above the chamber ambient.

14. The method of claim 11 wherein the wafer is loaded into the processing chamber at an ambient pressure that is at least 15% of atmospheric.
